(19) United States
(12) Patent Application Publication
(10) Pub. No.: US 2018/0194359 A1
(43) Pub. Date: Jul. 12, 2018

(54) OPERATION SUPPORT DEVICE AND OPERATION SUPPORT SYSTEM

(71) Applicant: Mitsubishi Electric Corporation, Tokyo (JP)

(72) Inventors: Takuji MORIMOTO, Tokyo (JP); Kimika IKEGAMI, Tokyo (JP); Shogo OKAMOTO, Tokyo (JP)

(73) Assignee: Mitsubishi Electric Corporation, Tokyo (JP)

(21) Appl. No.: 15/740,597

(22) PCT Filed: Aug. 10, 2015
(86) PCT No.: PCT/JP2015/072652

§ 371 Date: Dec. 28, 2017

(51) Int. Cl. B60W 50/00; G06F 3/0487; B60K 35/00

(52) U.S. Cl. CPC B60W 50/0097; B60W 50/0098; G06F 3/0487; B60W 2050/0089; B60K 2350/1076; B60K 2350/2008; B60K 35/00

(57) ABSTRACT

An intention inference part infers a future intention of a user. A time calculator to calculate an available time during which operation is properly executable, the operation corresponding to the feature intention of the user inferred by the intention inference part. A determination part determines, on a basis of the available time, whether the operation is executable or not. A recommendation-mode determination part controls an output device to output content of the operation in different modes depending on a determination of the determination part regarding whether the operation is executable or not.

### TECHNICAL FIELD

The present invention relates to an operation support device and an operation support system, each recommending operation corresponding to an intention of a user and each leading to execution of the operation.

### BACKGROUND ART

Patent Literature 1 as an example discloses a vehicle display controlling device which displays full menu information prompting selection of processing of equipment mounted on a vehicle while the vehicle is stopped, and displays, while the vehicle is traveling, modified menu information obtained by modifying the full menu information into simple contents.

Furthermore, this device creates the modified menu information on the basis of operation history information of the user such that menu items with higher selection frequencies are preferentially displayed.

Specifically, the operation which is frequently executed on a regular basis is determined as the operation intended by the user, and a display order and the like in menu items related to this operation are changed accordingly. In this manner, the user can preferentially select menu items frequently used, whereby the user's burden of the operation can be reduced.

### CITATION LIST

Patent Literature 1: JP 2004-249840 A

### SUMMARY OF INVENTION

However, the vehicle condition changes from moment to moment in the actual traveling environment of the vehicle.

Therefore, even when the operation determined as being the operation intended by the user is preferentially suggested as described above, there are some cases where the operation cannot be executed depending on the condition of the vehicle.

For example, it is assumed that the operation of “Turn on the television.” is preferentially suggested as the operation corresponding to the user's intention on the basis of the operation history information indicating that a television is frequently watched in the vehicle. However, even in this case, when the vehicle is traveling at this time, the driver cannot watch the television due to restrictions on the operation during traveling. As a result, the suggested operation is inexecutable.

With the conventional art represented by Patent Literature 1, there is a possibility that inexecutable operation is preferentially suggested, as described above. In this case, even if the user selects the suggested operation to instruct execution, this operation is not executed and the intention of the user is not accomplished. Consequently, the user's selection of the operation is wasted and the user's convenience is impaired, whereby the user may feel dissatisfied with the device.

The present invention has been made to solve the above-described issue, and an object of the invention is to obtain an operation support device and an operation support system, each of which is capable of accomplishing an intention of a user through recommended operation and reducing dissatisfaction of the user with the device in terms of convenience.

An operation support device according to the present invention includes an intention inference part, a determination part, and a recommendation-mode determination part.

The intention inference part is configured to infer a future intention of a user. The determination part is configured to determine whether operation corresponding to the feature intention of the user inferred by the intention inference part is executable or not. The recommendation-mode determination part is configured to control an output device to output content of the operation in different modes depending on a determination of the determination part regarding whether the operation is executable or not.

According to the present invention, the operation corresponding to the inferred intention of the user is recommended in different modes depending on whether the operation is executable or not. This allows the user to smoothly select the executable operation, whereby the intention of the user is smoothly accomplished. Furthermore, since the user is prevented from selecting inexecutable operation, it is possible to reduce dissatisfaction of the user with the device in terms of convenience.

### BRIEF DESCRIPTION OF DRAWINGS

FIG. 1 is a block diagram illustrating a structure of an operation support system according to Embodiment 1 of the present invention.

FIGS. 2A and 2B are block diagrams, each illustrating a hardware structure of an operation support device according to the Embodiment 1.

FIG. 3 is a flowchart illustrating an overview of operations of the operation support device according to the Embodiment 1.

FIG. 4 is a flowchart illustrating detailed operation of the operation support device according to the Embodiment 1.

FIG. 5 is a block diagram illustrating a structure of an operation support system according to Embodiment 2 of the present invention.

FIG. 6 is a flowchart illustrating operations of an operation support device according to the Embodiment 2.

FIG. 7 is a block diagram illustrating a structure of an operation support system according to Embodiment 3 of the present invention.

FIG. 8 is a flowchart illustrating operations of an operation support device according to the Embodiment 3.

FIG. 9 is a block diagram illustrating a structure of an operation support system according to Embodiment 4 of the present invention.

FIG. 10 is a flowchart illustrating operations of an operation support device according to the Embodiment 4.

FIG. 11 is a block diagram illustrating a structure of an operation support system according to Embodiment 5 of the present invention.

FIG. 12 is a flowchart illustrating operations of an operation support device according to the Embodiment 5.

FIG. 13 is a block diagram illustrating a structure of an operation support system according to Embodiment 6 of the present invention.

FIG. 14 is a diagram illustrating a hierarchical relationship among operation content for each abstraction level.

FIG. 15 is a diagram illustrating contents of a category and a brand.

FIG. 16 is a flowchart illustrating operations of an operation support device according to the Embodiment 6.

FIG. 17 is a block diagram illustrating a structure of an operation support system according to Embodiment 7 of the present invention.

FIG. 18 is a block diagram illustrating a structure of an operation support system according to Embodiment 8 of the present invention.

### DESCRIPTION OF EMBODIMENTS

Embodiments of the present invention will be described below with reference to the accompanying drawings to describe the present invention in further detail.

### Embodiment 1

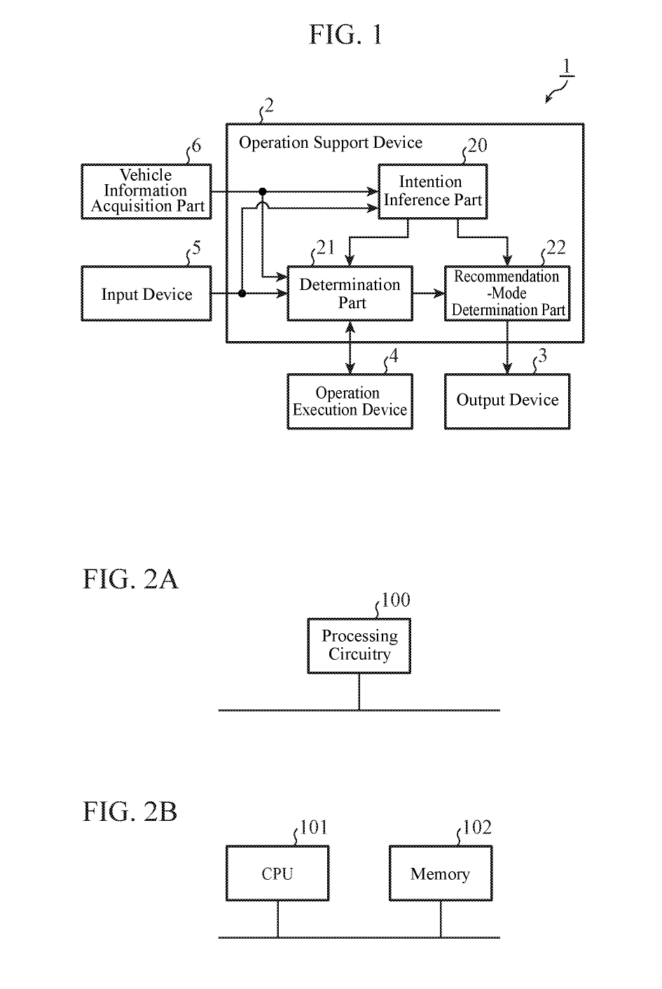

FIG. 1 is a block diagram illustrating a structure of an operation support system 1 according to Embodiment 1 of the present invention. The operation support system 1 is configured to recommend, from among operations of equipment mounted in the vehicle, the operation corresponding to an intention of a user being an occupant to lead to execution of the operation. As illustrated in FIG. 1, the operation support system 1 includes an operation support device 2, an output device 3, an operation execution device 4, an input device 5, and a vehicle information acquisition part 6. The operation support device 2 is configured to infer a future intention of the user and control the output device 3 to output content of the operation corresponding to the inferred intention as recommended operation. The operation support device 2 includes an intention inference part 20, a determination part 21, and a recommendation-mode determination part 22.

The output device 3 serves as a display device displaying information input from the operation support device 2 and a voice output device outputting the information with voice. For example, the output device 3 may be implemented by a built-in display of a dashboard in the vehicle, a head-up display that superimposes and displays information about a driver's forward view, an in-vehicle speaker, or the like.

Note that the output device 3 outputs content of the operation in a mode determined by the recommendation-mode determination part 22, which will be described later. Assuming that “Turn on the television.” is given as the operation corresponding to the user's intention, “Do you want to turn on the television?” as the content, for example, is output with voice or is displayed. When the user selects the operation by using the input device 5 on the basis of the output content, the operation is executed by the operation execution device 4.

The operation execution device 4 is configured to execute the operation recommended by the operation support device 2. The operation execution device 4 may be implemented by, for example, equipment mounted in the vehicle.

The equipment mounted in the vehicle may include a device for opening and closing windows of the vehicle and information equipment brought into the vehicle, in addition to a navigation device, an audio device, a television receiving device, a radio receiving device, a hands-free phone, and an air conditioning device inside the vehicle.

Note that, although FIG. 1 illustrates the case where the operation support device 2 and the operation execution device 4 are separate devices, the operation support device 2 may be implemented as one of the functions of the operation execution device 4.

The input device 5 is configured to receive information input from the user, and is implemented by, for example, a push button device, a touch panel, or the like. The recommended operation output by the output device 3 can be selected by using the input device 5.

In addition, the information about the user's operation of the input device 5 is used by the intention inference part 20 to infer the intention of the user, as described later.

The vehicle information acquisition part 6 is configured to acquire vehicle information and output the vehicle information to the operation support device 2. The vehicle information indicates the vehicle condition, and may include positional information of the vehicle, information indicating a traveling condition, information indicating a location of travel, and route guidance information.

In addition, the vehicle information acquisition part 6 may be provided as one of the functions of various sensors, an electronic control unit (ECU), and the like, which serve as information sources providing the vehicle information. Alternatively, the vehicle information acquisition part 6 may be provided as function of the operation support device 2.

The positional information of the vehicle is acquired from a position detecting device mounted in the vehicle. The positional information may be information indicating the current position of the vehicle, which is acquired by analyzing signals of a global positioning system (GPS) received by a GPS receiver from a GPS satellite, for example.

Alternatively, the positional information may be information rectified by using a direction sensor and a vehicle speed pulse.

The information indicating the traveling condition of the vehicle is acquired from a sensor or a vehicle controlling device mounted in the vehicle. The example of this information includes driving behavior of the vehicle predicted from the vehicle speed, the acceleration, the steering angle, and the remaining fuel amount, for example.

The information indicating the location of travel relates to a road on which the vehicle is traveling and also relates to an area in the vicinity of the road. This information may be acquired from the navigation device mounted in the vehicle, for example.

The information about a road on which the vehicle is traveling may indicate a type of the road, road condition, and traffic condition of the road. The road condition can be identified by analyzing an image of photographing information of an in-vehicle camera. The information about the area in the vicinity of the road may include facility information or the like in the vicinity area acquired from map information. The route guidance information relates to a route from a starting point to a destination, and may includes information about points of guidance such as intersections, and facilities, roads, and place names in the vicinity of the route, for example.

The intention inference part 20 is configured to infer the future intention of the user on the basis of the information input from the input device 5 or the vehicle information acquired by the vehicle information acquisition part 6. Note that the future intention of the user indicates a matter intended by the user within a few minutes after the current time.

The intention of the user may be inferred by using rule data, in which the vehicle condition identified by the above-described vehicle information and the intention content of the user are associated with each other.

For example, assuming that “The road type of the traveling road has changed from an expressway to a general road.” as the vehicle condition is associated with the matter “I want to go to a convenience store.”, the user's intention is inferred as “I want to go to a convenience store.” when the vehicle moves from the expressway to the general road.

Another rule data may be used, which is obtained by associating, in addition to the vehicle condition, the operation information input through the input device 5 with the intention content of the user. For example, assuming that the user always plays back a specific song while driving home, the operation of playing back this song and the user's intention “I want to go home” are associated with each other in the rule data.

The intention inference part 20 recognizes the user's intention as the user's behavior and learns the combination of the user's behavior and the vehicle information at that time. By referring to the learned data accumulated in this manner, the intention inference part 20 infers the user's behavior corresponding to the vehicle information at that time as the future intention of the user.

The correspondence among information pieces in the above-described learned data or rule data may be stochastically determined by performing a statistical method on history information about the user's behavior or the like.

The determination part 21 is configured to determine whether the operation corresponding to the intention of the user inferred by the intention inference part 20 is executable or not. The operation corresponding to the user's intention may be identified by using table data dedicated to identifying operation. In the table data, individual contents of intention and operation are associated with each other. For example, the user's intention “I want to go to the restroom.” is associated in advance with the operation “Search for convenience stores in the vicinity.” in the table data. This configuration is capable of recommending to the user a convenience store having the restroom.

For another example, by associating the user's intention “I want to go home.” with the operation “Search for a route to my home.”, the search operation for the route to his/her home can be recommended to the user.

For determining whether the operation corresponding to the user's intention is executable or not, table data dedicated to determining the availability of operation may be used. In this table data, individual operation contents are associated with a corresponding restriction criterion for restricting operation. The restriction criterion is identified from the vehicle information described above.

For example, the operation “Turn on the television.” is associated in advance with a restriction criterion “Travel of the vehicle” in the above-described table data. In this case, even if the operation “Turn on the television.” is inferred as corresponding to the user's intention, this operation is determined to be inexecutable when the vehicle is determined from the vehicle information as being traveling. On the other hand, when it is determined from the vehicle information that the vehicle is stopped, the above operation is determined as being executable since it does not confirm with the restriction criterion. Therefore, it is capable of determining the availability of operation depending on the actual vehicle condition.

The recommendation-mode determination part 22 is configured to control the output device 3 to output content of the operation in different modes depending on a determination of the determination part 21 regarding whether the operation is executable or not.

Note that the modes determined by the recommendation-mode determination part 22 include a mode of controlling the output device 3 not to output the operation. Therefore, the operation determined by the determination part 21 to be inexecutable is not necessary to be suggested to the user.

Alternatively, the output device 3 may be controlled to output by voice or display that the operation is inexecutable.

In order to display that the operation is inexecutable, display information for selecting this operation, such as a shortcut button, may be grayed out. This enables the user to easily recognize that this operation is inexecutable.

The operation determined by the determination part 21 to be executable may be output by voice or displayed through the output device 3 in a selectable style as recommended operation.

When the recommended operation is output by voice, the input device 5 is used for receiving a response to whether or not to select this operation. When the recommended operation is displayed, a shortcut button or text is displayed for selecting the recommended operation. By clicking the shortcut button or the text with the input device 5, the recommended operation is selected.

Note that, preferably, the output device 3 employs a mode of inquiring the user whether the recommended operation should be executed. For example, when the operation content is “Turn on the television”, “Do you want to turn on the television?” is output by voice or displayed in the form of inquiry. This also serves as an inquiry about whether the user's intention inferred by the intention inference part 20 is correct or not.

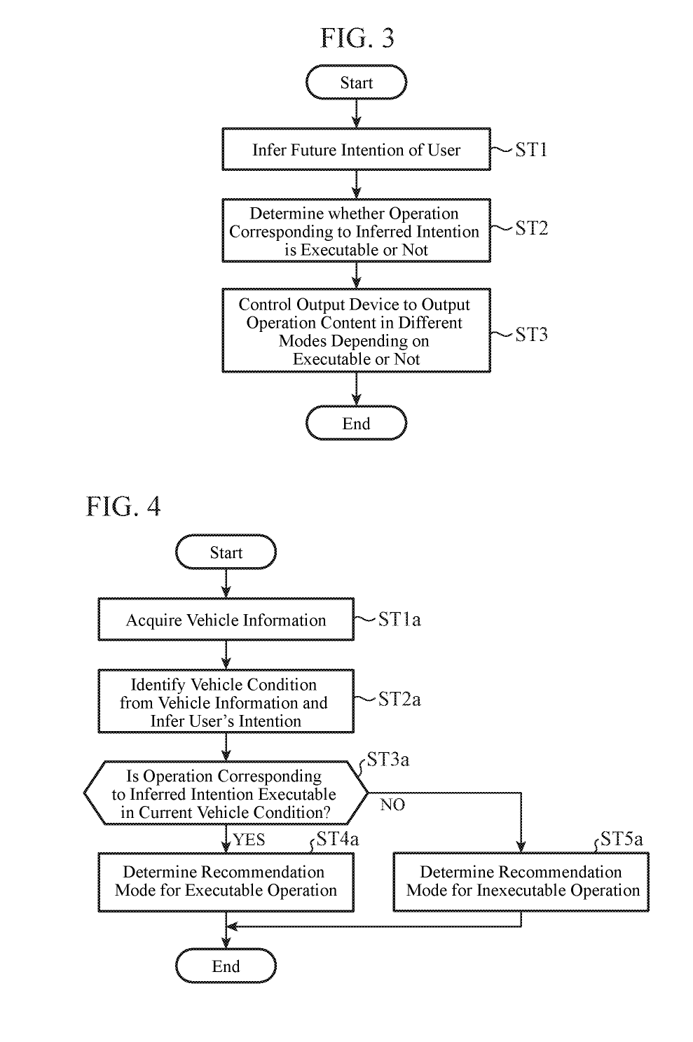

FIGS. 2A and 2B are block diagrams, each illustrating a hardware structure of an operation support device 2. FIG. 3 is a flowchart illustrating an overview of operations of the operation support device 2.

Each function of the intention inference part 20, the determination part 21, and the recommendation-mode determination part 22 in the operation support device 2 is implemented by processing circuitry. That is, the operation support device 2 includes the processing circuitry for executing the processing from step ST1 to step ST3 illustrated in FIG. 3. The processing circuitry may be dedicated hardware or may be a central processing unit (CPU) that executes programs stored in a memory.

As illustrated in FIG. 2A, when the above processing circuitry is processing circuitry 100 which is dedicated hardware, the processing circuitry 100 may be, for example, single circuitry, composite circuitry, a programmed processor, a parallel programmed processor, application specific integrated circuitry (ASIC), a field-programmable gate array (FPGA), or a combination thereof. The processing circuitry 100 may be implemented by processing circuitry corresponding to the functions of each of the intention inference part 20, the determination part 21, and the recommendation-mode determination part 22, or implemented by single processing circuitry integrating the functions thereof.

As illustrated in FIG. 2B, when the processing circuitry is a CPU 101, the functions of the intention inference part 20, the determination part 21, and the recommendation-mode determination part 22 are implemented by software, firmware, or a combination of software and firmware. The software and the firmware are described as programs and stored in a memory 102.

The CPU 101 implements the functions of each of the parts by reading and executing the programs stored in the memory 102. That is, the operation support device 2 includes the memory 102 for storing the programs by which the processing from step ST1 to step ST3 illustrated in FIG. 3 is consequently executed when the programs are executed by the CPU 101.

Furthermore, these programs control the computer to execute the procedures or methods for the intention inference part 20, the determination part 21, and the recommendation-mode determination part 22.

Examples of the memory 102 include a nonvolatile or volatile semiconductor memory such as a random access memory (RAM), a ROM, a flash memory, an erasable programmable ROM (EPROM), and an electrically EPROM (EEPROM), a magnetic disk, a flexible disk, an optical disk, a compact disc, a mini disc, a digital versatile disk (DVD), and the like.

Note that some of the functions of the intention inference part 20, the determination part 21, and the recommendation-mode determination part 22 may be implemented by dedicated hardware, and the remainder may be implemented by software or firmware. For example, the function of the intention inference part 20 can be implemented by the processing circuitry 100 serving as dedicated hardware, whereas the functions of the determination part 21 and the recommendation-mode determination part 22 can be implemented by the CPU 101 reading and executing the programs stored in the memory 102.

In this manner, the processing circuitry can implement the above-described functions by means of hardware, software, firmware, or a combination thereof.

Next, the operations will be described.

FIG. 4 is a flowchart illustrating the detailed operations of the operation support device 2.

In FIG. 4, the processing in step ST1a and step ST2a is an example of the detailed processing in step ST1 of FIG. 3. The processing in step ST3a is an example of the detailed processing in step ST2 of FIG. 3, and the processing in step ST4a and step ST5a is an example of the detailed processing in step ST3 of FIG. 3.

Since the operation in each step of FIG. 3 will be apparent from the description of each step of FIG. 4, the following description will be made based on FIG. 4.

While the operation support device 2 is being activated, the intention inference part 20 receives the vehicle information acquired by the vehicle information acquisition part 6 (step ST1a). For example, when a future intention of the user at a predetermined period of time after the current time is inferred, the vehicle information is acquired with a cycle having a period shorter than the predetermined period of time.

The intention inference part 20 identifies the vehicle condition on the basis of the vehicle information, and infers the future intention of the user from the vehicle condition (step ST2a).

For example, with referring to the rule data in which vehicle condition is associated with content of the user's intention, content of the intention corresponding to the current vehicle condition is inferred as an intention of the user.

Note that, as described above, the intention inference part 20 may infer the intention of the user by also using the operation information input through the input device 5 in addition to the vehicle information from the vehicle information acquisition part 6.

The determination part 21 identifies the operation corresponding to the intention inferred in this manner and determines whether the identified operation is executable or not under the current vehicle condition (step ST3a).

For example, the operation corresponding to the intention inferred by the intention inference part 20 is identified by referring to the table data dedicated to identifying operation. In this table data, individual contents of intention and operation are associated with each other.

Furthermore, the table data dedicated to determining the availability of operation is used. In this table data, individual operation contents are associated with a corresponding restriction criterion for restricting operation. When the vehicle condition conforms with the restriction criterion, the operation is determined as being inexecutable. When the vehicle condition does not conform with the restriction criterion, the operation is determined as being executable.

When it is determined by the determination part 21 that the operation is executable (step ST3a; YES), the recommendation-mode determination part 22 determines a recommendation mode corresponding to the determination result indicating that this operation is executable (step ST4a). The output device 3 outputs content of the operation in the recommendation mode determined by the recommendation-mode determination part 22. In this manner, the operation determined by the determination part 21 to be executable is output as the recommended operation through the output device 3.

For example, voice guidance for prompting selection of the recommended operation is output, or a shortcut button or text for prompting selection of the recommended operation is displayed.

When it is determined by the determination part 21 that the operation is inexecutable (step ST3a; NO), the recommendation-mode determination part 22 determines a recommendation mode corresponding to the determination result indicating that the operation is inexecutable (step ST5a). Similarly to above, the output device 3 outputs this operation in the mode determined by the recommendation-mode determination part 22.

For example, voice guidance is output to indicate that the operation is inexecutable even if selected, or a shortcut button or text, which prompts selection of this operation, is grayed out. Alternatively, when the operation is inexecutable, the operation is not necessary to be output by the output device 3.

Thereafter, on the basis of the output content of the output device 3, the user determines whether or not to execute the recommended operation suggested by the operation support device 2. In order to execute the recommended operation, the user selects this operation by using the input device 5. For example, the shortcut button for selecting this operation is clicked. When the selection of the recommended operation is entered through the input device 5, the determination part 21 instructs the operation execution device 4 to execute this operation. The operation execution device 4 executes the recommended operation in accordance with the instruction from the determination part 21.

As described above, the operation support device 2 according to the Embodiment 1 includes the intention inference part 20, the determination part 21, and the recommendation-mode determination part 22. The intention inference part 20 infers the future intention of the user. The determination part 21 determines whether the operation corresponding to the intention of the user inferred by the intention inference part 20 is executable or not. The recommendation-mode determination part 22 controls the output device 3 to output content of the operation corresponding to the user's intention in different modes depending on the determination of the determination part 21 regarding whether the operation is executable or not.

In this manner, the operation corresponding to the user's intention is recommended in different modes depending on whether the operation is executable or not. This allows the user to select the executable operation easily, whereby the user's intention is smoothly accomplished. In addition, since the user is prevented from selecting inexecutable operation, it is possible to reduce dissatisfaction of the user with the operation support device 2 in terms of convenience.

In the operation support device 2 according to the Embodiment 1, the determination part 21 determines whether the operation is executable or not on the basis of the vehicle condition indicated by the vehicle information. By employing this configuration, the availability of operation can be determined depending on the actual vehicle condition.

### Embodiment 2

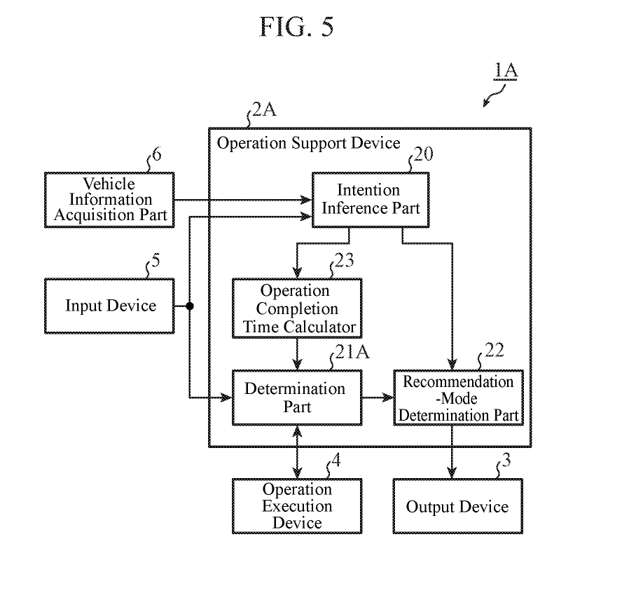

FIG. 5 is a block diagram illustrating a structure of an operation support system 1A according to Embodiment 2 of the present invention. The operation support system 1A is configured to recommend, from among the operations of equipment mounted in the vehicle, the operation corresponding to the intention of the user being an occupant, and lead to execution of the recommended operation. As illustrated in FIG. 5, the operation support system 1A includes an operation support device 2A, an output device 3, an operation execution device 4, an input device 5, and a vehicle information acquisition part 6. The operation support device 2A is configured to infer a future intention of the user and control the output device 3 to output the operation corresponding to the inferred intention. The operation support device 2A includes an intention inference part 20, a determination part 21A, a recommendation-mode determination part 22, and an operation completion time calculator 23.

Note that the same components as those in FIG. 1 are denoted by the same signs in FIG. 5, and the description thereof is omitted.

The operation completion time calculator 23 is a structural element embodying a first time calculator according to the present invention. The operation completion time calculator 23 is configured to calculate intention accomplishment time information, which includes a required time from when the operation corresponding to the user's intention is selected until execution of the selected operation is completed. The intention accomplishment time information substantially indicates a required time until the user's intention is accomplished. This information may include, in addition to an operation completion time of the operation, which will be described later, the number of operations performed until the user's intention is accomplished, and the number of times that the driver keeps his/her eyes off the forward sight of the vehicle to perform the operation until the driver's intention is accomplished.

The operation completion time is a required time from when the recommended operation is selected until execution of this operation is completed. Note that the user's intention corresponding to the operation is accomplished by completing execution of this operation after selecting it. Thus, the operation completion time is equivalent to the required time until the user's intention is accomplished.

Alternatively, the operation completion time may be calculated by using table data, in which an operation completion time preliminarily measured and content of the intention are associated with each other.

For example, the table data is created by measuring the actual operation completion time from when the user selects operation until execution of this operation is completed, and associating the measured time as the operation completion time with the intention content. By referring to this table data, the operation completion time calculator 23 is able to calculate the operation completion time corresponding to the user's intention inferred by the intention inference part 20.

Alternatively, table data, in which the average of operation completion times regarding the operation corresponding to the intention is set, may be used. The average of operation completion times is obtained by, for example, measuring multiple times the actual operation completion time and averaging the multiple measurement results.

Furthermore, table data, in which contents of the user's intention are classified into different categories and the average of the operation completion time is set for each of the categories, may also be used.

For example, assuming that the category of the intention content is “searches”, the average of the operation completion time required for the overall searches is set in the table data as a conclusive operation completion time.

The operation corresponding to the user's intention may consist of a combination of a plurality of sub-operations. In this case, the sub-operations are sequentially executed from when the recommended operation is selected until the execution of thereof is completed. For example, it is assumed that the operation “Search for convenience stores and provide guidance for them along the route.” is the selected recommended operation. In this case, the time when the execution of this operation finally completes is at the time when a convenience store selected from search results is set as a destination of the route after convenience stores of a specific brand selected by the user are searched for along the route. Specifically, the operation completion time indicates the time required for the sub-operations (1) to (3) below:

(1) A specific brand is selected from a brand list of convenience stores.

(2) Convenience stores of the selected brand are searched for and a list of the search results is displayed.

(3) A convenience store selected from the list is set as the destination.

Similarly to the operation completion time explained above, the number of operations performed until the intention is accomplished may be calculated by using table data. In this table data, the number of operations which has been preliminarily measured is associated with contents of the intention. For example, assuming that the above-described operation “Search for convenience stores and provide guidance for them along the route.” is given, the number of operations performed until the intention is accomplished is three.

Furthermore, table data may be used for calculating the number of times that the driver keeps his/her eyes off the forward sight of the vehicle to perform the operation until the driver's intention is accomplished. In this table data, for example, the result of measuring this number in advance and the intention content are associated with each other. The number of times the driver keeps his/her eyes off the forward sight may be obtained by analyzing an image of photographing information about this driver and counting the number of times the driver's line of sight is deviated from the forward.

On the basis of the operation completion time calculated by the operation completion time calculator 23, the determination part 21A determines whether the operation corresponding to the intention of the user inferred by the intention inference part 20 is executable or not. For example, the operation completion time is compared with a predetermined threshold value, and the operation is determined as being inexecutable when the operation completion time is equal to or more than the threshold value, whereas the operation is determined as being executable when the operation completion time is less than the threshold value. The operation functions permitted in a traveling vehicle are defined by guidelines in detail, and a period of time during which the driver can view a screen is also defined. On this account, such time explained above is used as a threshold value.

Furthermore, the number of operations performed until the intention is accomplished or the number of times that the driver keeps his/her eyes off the forward sight to perform the operation may also be determined in the same manner.

That is to say, such number is compared with a predetermined threshold value, and the operation is determined as being inexecutable when this number is equal to or more than the threshold value, whereas the operation is determined as being executable when this number is less than the threshold value.

Furthermore, the threshold value used for the determination may be changed dynamically depending on the vehicle condition.

The threshold value serving as the allowable upper limit value is lowered when the vehicle is traveling, whereas the threshold value serving as the allowable upper limit value is increased when the vehicle is being stopped. By employing this configuration, it is possible to make an appropriate determination corresponding to the vehicle condition. For example, the threshold value of the operation completion time may be set to 8 seconds during the traveling state, whereas being set to 20 seconds during the stopped state.

Note that the respective functions of the intention inference part 20, the determination part 21A, the recommendation-mode determination part 22, and the operation completion time calculator 23 may be, as with the Embodiment 1, implemented by dedicated hardware, or implemented by software or firmware. In addition, some of these functions may be implemented by dedicated hardware, whereas the remainder may be implemented by software or firmware.

Next, the operations will be described.

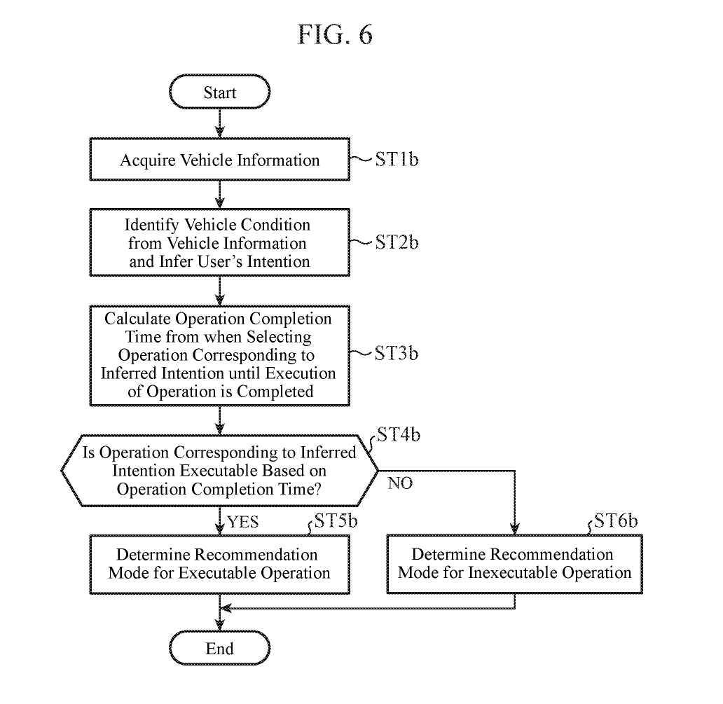

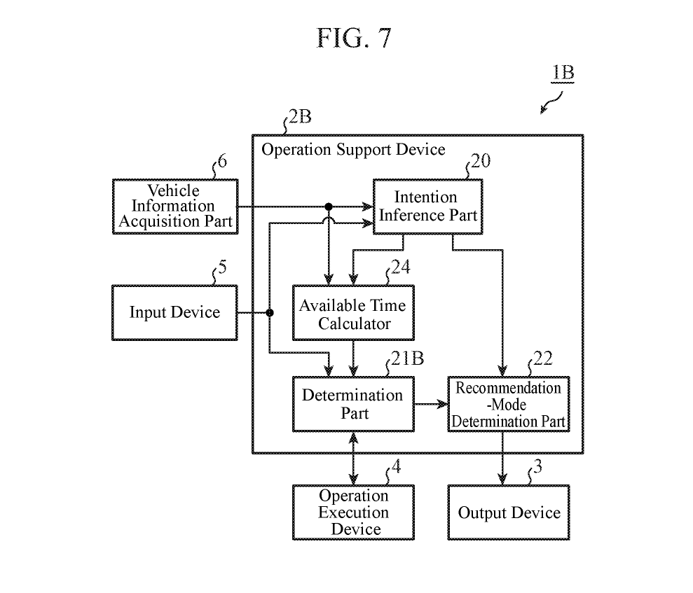

FIG. 6 is a flowchart illustrating the detailed operations of the operation support device 2A.

In FIG. 6, the processing in step ST1b and step ST2b is similar to the processing in step ST1a and step ST2a in FIG. 4 illustrated in the Embodiment 1. In addition, the processing in step ST5b and step ST6b is similar to the processing in step ST4a and step ST5a in FIG. 4. Therefore, the description of those steps is omitted.

In step ST3b, the operation completion time calculator 23 calculates the operation completion time, which is a required time from when the recommended operation is selected until execution of this operation is completed.

For example, the operation completion time calculator 23 determines the operation completion time corresponding to the intention content by acquiring the intention content of the user inferred by the intention inference part 20 and referring to the table data in which the operation completion time is associated with the intention content.

On the basis of the operation completion time input from the operation completion time calculator 23, the determination part 21A determines whether the operation corresponding to the intention of the user is executable or not (step ST4b).

For example, the operation completion time is compared with a predetermined threshold value. When the operation completion time is equal to or more than the threshold value, the operation is determined as being inexecutable (step ST4b; NO). On the other hand, when the operation completion time is less than the threshold value, the operation is determined as being executable (step ST4b; YES).

As described above, the operation support device 2A according to the Embodiment 2 includes the operation completion time calculator 23 that calculates the operation completion time, which is a required time from when the recommended operation is selected until execution of this operation is completed. On the basis of the operation completion time, the determination part 21A determines whether the operation corresponding to the intention of the user is executable or not.

In this manner, the operation corresponding to the inferred intention of the user is recommended in different modes depending on whether the operation is executable or not. This allows the user to select the executable operation easily, whereby the intention of the user is smoothly accomplished. Furthermore, since the user is prevented from selecting inexecutable operation, it is possible to reduce dissatisfaction of the user with the operation support device 2A in terms of convenience.

### Embodiment 3

FIG. 7 is a block diagram illustrating a structure of an operation support system 1B according to Embodiment 3 of the present invention. The operation support system 1B is configured to recommend, from among the operations of equipment mounted in the vehicle, the operation corresponding to the intention of the user being an occupant to lead to execution of the operation. As illustrated in FIG. 7, the operation support system 1B includes an operation support device 2B, an output device 3, an operation execution device 4, an input device 5, and a vehicle information acquisition part 6. The operation support device 2B is configured to infer the future intention of the user and control the output device 3 to output the operation corresponding to this intention. The operation support device 2B includes an intention inference part 20, a determination part 21B, a recommendation-mode determination part 22, and an available time calculator 24.

Note that the same components as those in FIG. 1 are denoted by the same signs in FIG. 7, and the description thereof is omitted.

The available time calculator 24 is a structural element embodying a second time calculator according to the present invention, and is configured to calculate the available time. The available time is a period of time during which the operation corresponding to the user's intention inferred by the intention inference part 20 is properly executable.

On the basis of the available time calculated by the available time calculator 24, the determination part 21B determines whether the operation corresponding to the user's intention inferred by the intention inference part 20 is executable or not.

For example, the available time is compared with a threshold value. When the available time is equal to or less than the threshold value, the operation is determined as being inexecutable. When the available time exceeds the threshold value, the operation is determined as being executable.

Note that the respective functions of the intention inference part 20, the determination part 21B, the recommendation-mode determination part 22, and the available time calculator 24 may be, as with the Embodiment 1, implemented by dedicated hardware, or implemented by software or firmware. In addition, some of these functions may be implemented by dedicated hardware, whereas the remainder may be implemented by software or firmware.

Next, the operations will be described.

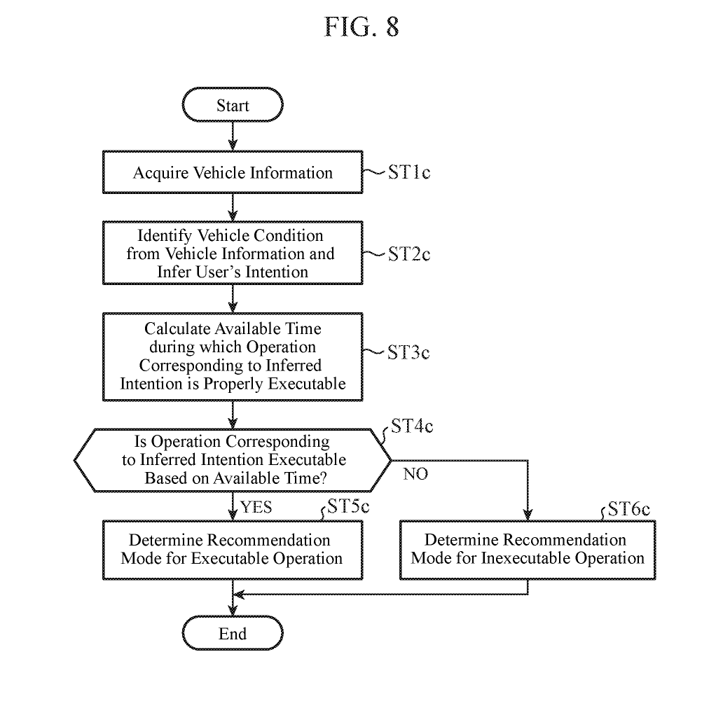

FIG. 8 is a flowchart illustrating the detailed operations of the operation support device 2B.

In FIG. 8, the processing in step ST1c and step ST2c is similar to the processing in step ST1a and step ST2a in FIG. 4 illustrated in the Embodiment 1. In addition, the processing in step ST5c and step ST6c is similar to the processing in step ST4a and step ST5a in FIG. 4. Therefore, the description of those steps is omitted.

The available time calculator 24 calculates the available time during which the operation corresponding to the intention of the user is properly executable (step ST3c).

For example, assuming that the intention inference part 20 infers that the intention of the user is “I want to inter the coming service area.”, the average of a travel time from the current position of the vehicle to the coming service area is recognized as the available time.

On the basis of the available time input from the available time calculator 24, the determination part 21B determines whether the operation corresponding to the intention of the user is executable or not (step ST4c).

For example, when the available time is equal to or less than the threshold value, the operation is determined as being inexecutable (step ST4c; NO). On the other hand, when the available time exceeds the threshold value, the operation is determined as being executable (step ST4c; YES).

As the threshold value of the available time, a predetermined threshold value may be given to each operation or each category of the intention content, which corresponds to the available time. For example, 10 seconds is set as the threshold value of the available time to the operation “Search for the coming service area” or to the category “Searches” of the intention content “I want to inter the coming service area”.

Note that the above threshold value may be set by the user as appropriate, or may be a value statistically calculated from the user's operation history.

As described above, the operation support device 2B according to the Embodiment 3 includes the available time calculator 24 that calculates the available time during which the operation corresponding to the user's intention inferred by the intention inference part 20 is properly executable. On the basis of the available time for the intention, the determination part 21B determines whether the operation corresponding to the user's intention is executable or not.

In this manner, the operation corresponding to the inferred user's intention is recommended in different modes depending on whether the operation is executable or not. This allows the user to select the executable operation easily, whereby the intention of the user is smoothly accomplished. Furthermore, since the user is prevented from selecting inexecutable operation, it is possible to reduce dissatisfaction of the user with the operation support device 2B in terms of convenience.

### Embodiment 4

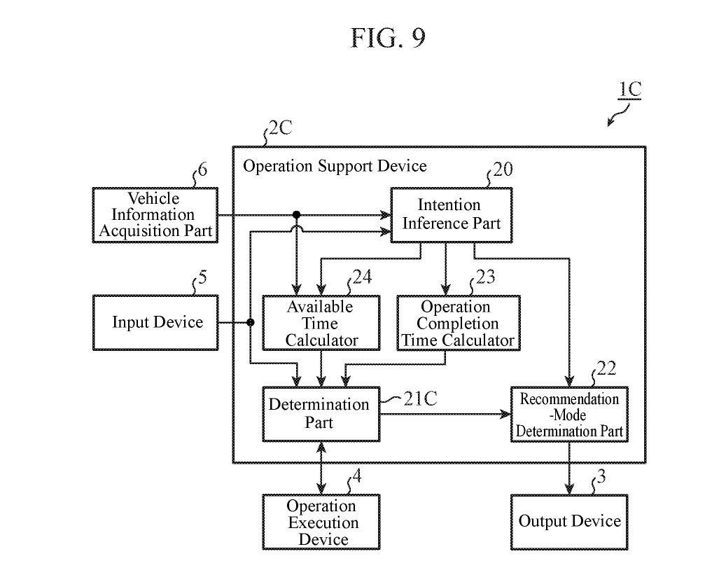

FIG. 9 is a block diagram illustrating a structure of an operation support system 1C according to Embodiment 4 of the present invention. The operation support system 1C is configured to recommend, from among the operations of equipment mounted in the vehicle, the operation corresponding to the intention of the user being an occupant to lead to execution of the operation. As illustrated in FIG. 9, the operation support system 1C includes an operation support device 2C, an output device 3, an operation execution device 4, an input device 5, and a vehicle information acquisition part 6. The operation support device 2C is configured to infer the future intention of the user and controls the output device 3 to output content of the operation corresponding to this intention. The operation support device 2C includes an intention inference part 20, a determination part 21C, a recommendation-mode determination part 22, an operation completion time calculator 23, and an available time calculator 24.

Note that the same components as those in FIGS. 1, 5, and 7 are denoted by the same signs in FIG. 9, and the description thereof is omitted.

On the basis of the operation completion time calculated by the operation completion time calculator 23 and the available time calculated by the available time calculator 24, the determination part 21C determines whether the operation corresponding to the user's intention inferred by the intention inference part 20 is executable or not.

For example, the available time is compared with the operation completion time. When the available time is equal to or less than the operation completion time, the operation is determined as being inexecutable. When the available time exceeds the operation completion time, the operation is determined as being executable.

Note that the respective functions of the intention inference part 20, the determination part 21C, the recommendation-mode determination part 22, the operation completion time calculator 23, and the available time calculator 24 may be, as with the Embodiment 1, implemented by dedicated hardware, or implemented by software or firmware. In addition, some of these functions may be implemented by dedicated hardware, whereas the remainder may be implemented by software or firmware.

Next, the operations will be described.

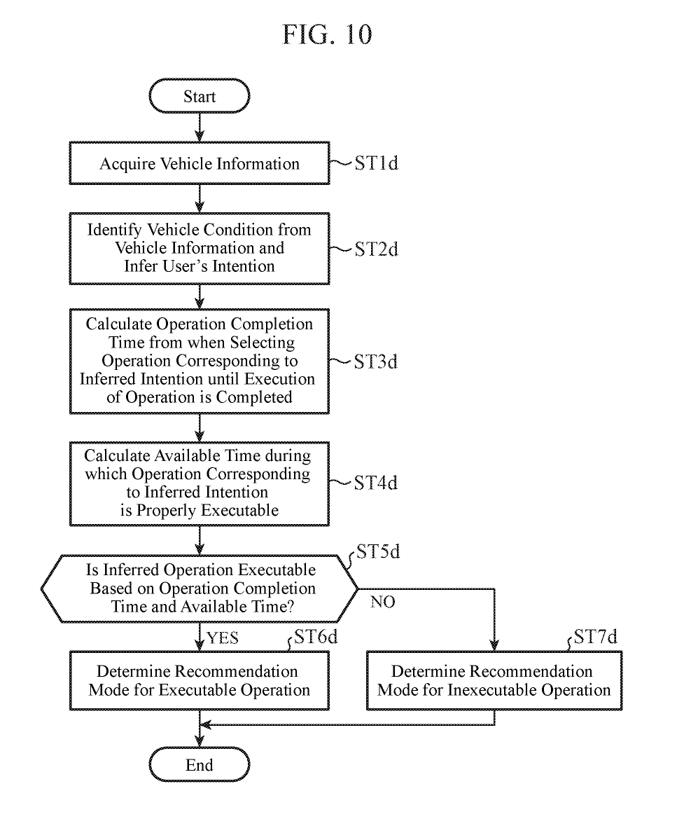

FIG. 10 is a flowchart illustrating the detailed operations of the operation support device 2C.

In FIG. 10, the processing in step ST1d and step ST2d is similar to the processing in step ST1a and step ST2a in FIG. 4 illustrated in the Embodiment 1. In addition, the processing in step ST3d is similar to the processing in step ST3b in FIG. 6 illustrated in the Embodiment 2. The processing in step ST4d is similar to the processing in step ST3c in FIG. 8 illustrated in the Embodiment 3. Furthermore, the processing in step ST6d and step ST7d is similar to the processing in step ST4a and step ST5a in FIG. 4. Therefore, the description of those steps is omitted.

In step ST5d, on the basis of the operation completion time and the available time, the determination part 21C determines whether the operation corresponding to the user's intention inferred by the intention inference part 20 is executable or not. For example, assuming that the user's intention is inferred as “I want to inter the coming service area.”, the available time calculator 24 calculates the average of the travel time from the current position of the vehicle to the coming service area as the available time.

In addition, the operation completion time calculator 23 calculates the operation completion time for the operation “Set the coming service area as the destination and search for the route”, which corresponds to the user's intention.

The determination part 21C compares the available time with the operation completion time. When the available time is equal to or less than the operation completion time, the determination part 21C determines that the operation is inexecutable, whereas determines that the operation is executable when the available time exceeds the operation completion time.

For example, assuming that the available time is 10 seconds and the operation completion time is 30 seconds, the 10-seconds available time is expired before the search operation is completed. In this case, it is determined that the user's intention “I want to inter the coming service area.” cannot be accomplished, and the operation is determined as being inexecutable.

As described above, the operation support device 2C according to the Embodiment 4 includes the operation completion time calculator 23 and the available time calculator 24. On the basis of the operation completion time and the available time, the determination part 21C determines whether the operation corresponding to the intention of the user is executable or not.

In this manner, the operation corresponding to the inferred intention of the user is recommended in different modes depending on whether the operation is executable or not. This allows the user to select the executable operation easily, whereby the intention of the user is smoothly accomplished. Furthermore, since the user is prevented from selecting inexecutable operation, it is possible to reduce dissatisfaction of the user with the operation support device 2C in terms of convenience.

### Embodiment 5

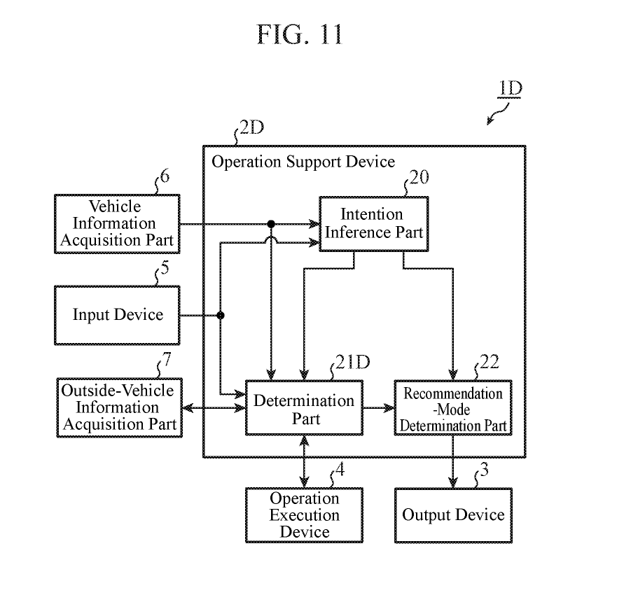

FIG. 11 is a block diagram illustrating a structure of an operation support system 1D according to Embodiment 5 of the present invention. The operation support system 1D is configured to recommend, from among the operations of equipment mounted in the vehicle, the operation corresponding to the intention of the user being an occupant to lead to execution of the operation. As illustrated in FIG. 11, the operation support system 1D includes an operation support device 2D, an output device 3, an operation execution device 4, an input device 5, a vehicle information acquisition part 6, and an outside-vehicle information acquisition part 7.

The operation support device 2D is configured to infer the future intention of the user and control the output device 3 to output content of the operation corresponding to this intention. The operation support device 2D includes an intention inference part 20, a determination part 21D, and a recommendation-mode determination part 22. Note that the same components as those in FIG. 1 are denoted by the same signs in FIG. 11, and the description thereof is omitted.

The outside-vehicle information acquisition part 7 is provided as one of the functions of a wireless communication device mounted in the vehicle, and is configured to acquire outside-vehicle information indicating a circumstance in the vicinity of the vehicle. For example, the outside-vehicle information acquisition part 7 performs wireless communication with an external device, which is an information source outside the vehicle, via a communication network such as the Internet, and searches for information managed by the external device on the basis of the operation content corresponding to the user's intention. In this manner, the outside-vehicle information corresponding to the above operation content and indicating the circumstance in the vicinity of the vehicle is received.

Note that examples of the outside-vehicle information may include information about traffic congestion and the like acquired from the traffic infrastructure, in addition to facility information, weather information, event information such as time-limited sales, and the like in the vicinity of the vehicle.

On the basis of the circumstance in the vicinity of the vehicle indicated in the outside-vehicle information acquired by the outside-vehicle information acquisition part 7, the determination part 21D determines whether the operation corresponding to the intention of the user inferred by the intention inference part 20 is executable or not. For example, assuming that “Go to the AAA ski resort.” is given as the operation corresponding to the user's intention whereas the outside-vehicle information indicating that the weather in the AAA ski resort is rainy is obtained, this operation is determined as being inexecutable.

Note that the respective functions of the intention inference part 20, the determination part 21D, and the recommendation-mode determination part 22 may be, as with the Embodiment 1, implemented by dedicated hardware, or implemented by software or firmware. In addition, some of these functions may be implemented by dedicated hardware, whereas the remainder may be implemented by software or firmware.

Next, the operations will be described.

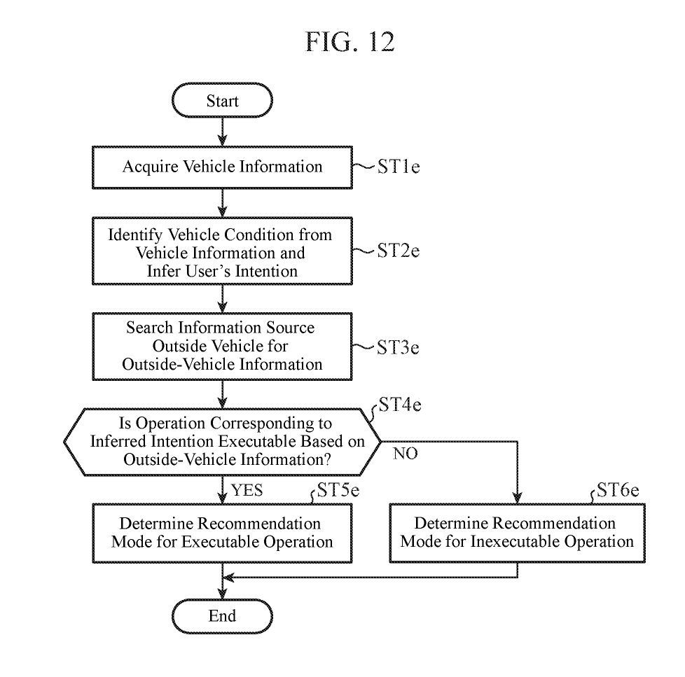

FIG. 12 is a flowchart illustrating the detailed operations of the operation support device 2D.

In FIG. 12, the processing in step ST1e and step ST2e is similar to the processing in step ST1a and step ST2a in FIG. 4 illustrated in the Embodiment 1. In addition, the processing in step ST5e and step ST6e is similar to the processing in step ST4a and step ST5a in FIG. 4. Therefore, the description of those steps is omitted.

On the basis of the information indicating the operation content corresponding to the user's intention acquired from the determination part 21D, the outside-vehicle information acquisition part 7 searches for information managed by an information source outside the vehicle and receives the outside-vehicle information corresponding to the operation content and indicating the circumstance in the vicinity of the vehicle (step ST3e).

For example, assuming that the operation corresponding to the user's intention is “Search for XXX parking lots in the vicinity.”, the space availability information about the XXX parking lots in the vicinity is acquired from the information source outside the vehicle.

On the basis of the circumstance in the vicinity of the vehicle indicated by the outside-vehicle information, the determination part 21D determines whether the operation corresponding to the user's intention is executable or not (step ST4e).

For example, assuming that “Search for XXX parking lots in the vicinity.” is given as the operation corresponding to the user's intention whereas the space availability information about the XXX parking lots in the vicinity acquired by the outside-vehicle information acquisition part 7 indicates full, this operation is determined as being inexecutable.

In the operation support device 2D according to the Embodiment 5, as described above, the determination part 21D determines whether the operation is executable or not on the basis of the circumstance in the vicinity of the vehicle indicated by the outside-vehicle information.

With such a structure, the availability of operation can be accurately determined depending on the basis of the circumstance in the vicinity of the vehicle.

### Embodiment 6

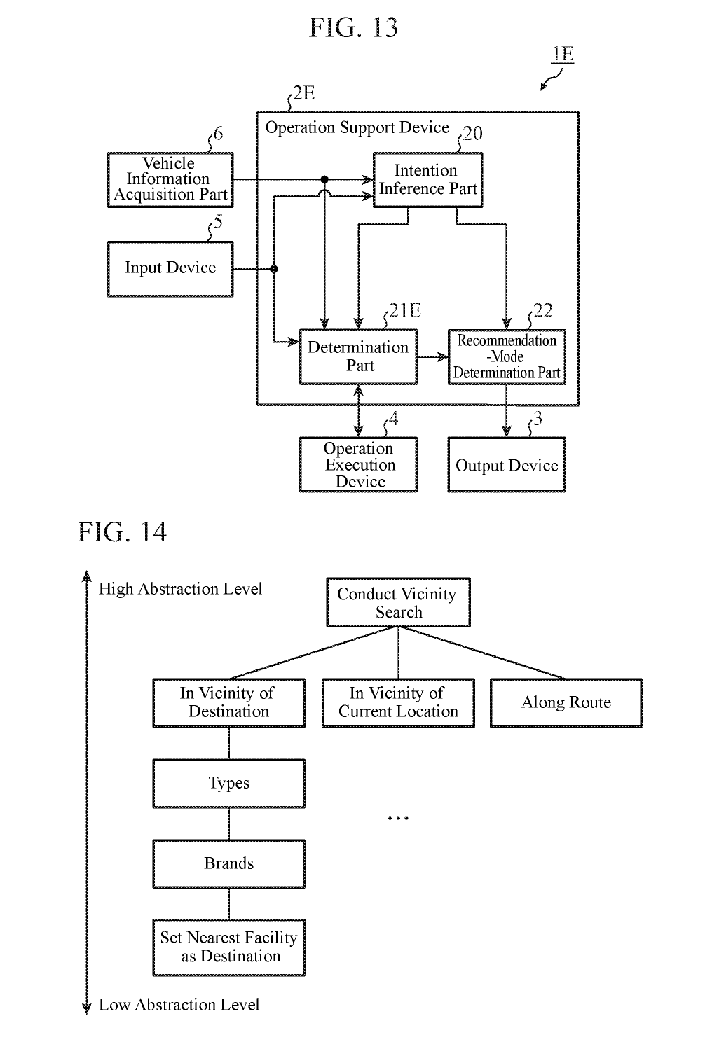

FIG. 13 is a block diagram illustrating a structure of an operation support system 1E according to Embodiment 6 of the present invention. The operation support system 1E is configured to recommend, from among the operations of equipment mounted in the vehicle, the operation corresponding to the intention of the user being an occupant to lead to the execution thereof. As illustrated in FIG. 13, the operation support system 1E includes an operation support device 2E, an output device 3, an operation execution device 4, an input device 5, and a vehicle information acquisition part 6. The operation support device 2E is configured to infer the future intention of the user and control the output device 3 to output content of the operation corresponding to the inferred intention. The operation support device 2E includes an intention inference part 20, a determination part 21E, and a recommendation-mode determination part 22. Note that the same components as those in FIG. 1 are denoted by the same signs in FIG. 13, and the description thereof is omitted.

When the operation corresponding to the user's intention is determined as being inexecutable, the determination part 21E changes the abstraction level of the contents of the operation until the operation becomes executable. The determination part 21E may have reference data for changing the abstraction level, such as illustrated in FIG. 14, in addition to the table data dedicated to identifying operation mentioned in the Embodiment 1, in which individual content of the intention and the operation content are associated with each other. In the reference data for changing the abstraction level, a hierarchical relationship among the operation content for each abstraction level is indicated. This reference data is structured such that the basic contents of the operation are set at the highest abstraction level in the hierarchy, and the lower the abstraction level, the more specific the contents of the operation become.

For example, a hierarchical relationship among the operation content for each abstraction level of the operation “Conduct vicinity search.” is set in the reference data illustrated in FIG. 14. Lowering the abstraction level from the most basic contents “Conduct vicinity search.”, the specified contents indicating which place the vicinity should be searched are set, such as “In the vicinity of the destination”, “In the vicinity of the current location”, and “Along the route”. When the target place is located “In the vicinity of the destination”, the operation content down to this level in the hierarchy indicates “Search the vicinity of the destination”. Subsequently, items “category” and “brand” are set as search targets.

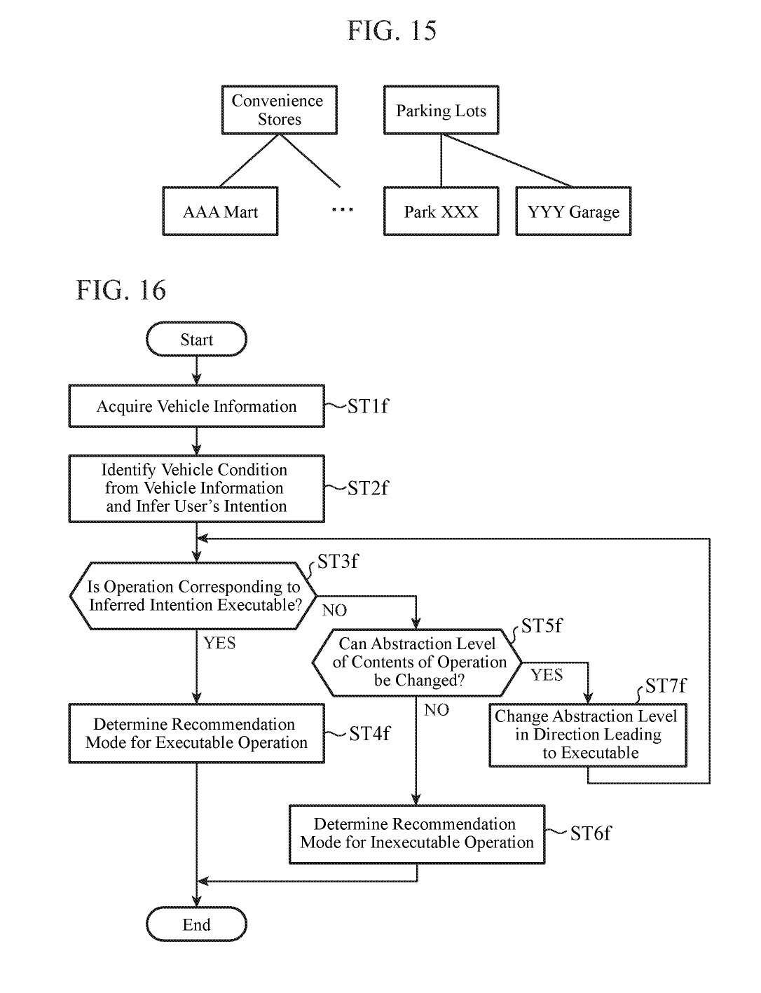

As illustrated in FIG. 15, the categories of facilities such as “convenience stores” and “parking lots” are set in the item “category”, and more specific facility brands such as “AAA mart” are set in the item “brand”.

Subsequent to the item “category” and the item “brand”, the operation content “Set the nearest facility as the destination” are set. Lowering the abstraction level to such operation content limits the search targets. Therefore, the time required to acquire the search result may be shortened in some cases.

In other words, even when it is determined that it takes too much time before completing the execution of the operation corresponding to the user's intention and thus the execution thereof is not possible, lowering the abstraction level of the operation content may shorten the time required to complete the execution of the operation and be executable.

When limiting the search targets results in failure to acquire a desired search result and leads to unsuccessful completion of the search operation, increasing the abstraction level of the operation content may conversely make it possible to acquire the search result close to the desired contents and complete the search operation.

Note that the respective functions of the intention inference part 20, the determination part 21E, and the recommendation-mode determination part 22 may be, as with the Embodiment 1, implemented by dedicated hardware, or implemented by software or firmware. In addition, some of these functions may be implemented by dedicated hardware, whereas the remainder may be implemented by software or firmware.

Next, the operations will be described.

FIG. 16 is a flowchart illustrating the detailed operations of the operation support device 2E.

Note that since the processing in steps ST1f to ST3f and step ST6f in FIG. 16 is similar to the processing in steps ST1a to ST3a and step ST5a in FIG. 4 illustrated in the Embodiment 1, the description of those steps is omitted.

When the determination part 21E determines that the operation corresponding the intention of the user is inexecutable (step ST3f; NO), the determination part 21E checks whether or not the abstraction level of the contents of this operation can be changed (step ST5f). The determination is made, for example, on the basis of whether the reference data as described above is available for the operation corresponding to the intention of the user. When the abstraction level of the contents of the above operation cannot be changed (step ST5f; NO), processing shifts to the processing in step ST6f.

On the other hand, when the abstraction level of the contents of the above operation can be changed (step ST5f; YES), the determination part 21E refers to the reference data described above and changes the abstraction level in the direction in which the above operation becomes executable (step ST7f).

For example, it may be assumed that the operation corresponding to the user's intention is “Search for convenience stores and provide guidance for them along the route.”, and this operation is inexecutable because the operation completion time thereof is equal to or more than the threshold value. In this case, the abstraction level is lowered and the operation is changed to “Search for the AAA mart in the vicinity and set the nearest facility as the destination.” so as to shorten the operation completion time.

For another example, it may be assumed that the operation corresponding to the intention of the user is “Search for Park XXX in the vicinity.”, and this operation is inexecutable because the space availability information of the outside-vehicle information indicates that the “Park XXX” is full. In this case, the abstraction level is increased and the operation is changed to “Search for parking lots in the vicinity.” so as to remove the limitation of the brand of the parking lot.

In step ST4f, the recommendation-mode determination part 22 controls the output device 3 to output, as alternative operation, the operation whose abstraction level of the contents has been changed by the determination part 21E until the operation become executable.

Alternatively, the recommendation-mode determination part 22 may control the output device 3 to output, as recommended operation, the operation determined by the determination part 21E to be inexecutable, and subsequently control the output device 3 to output a message indicating inexecutable and alternative operation whose abstraction level has been changed.

For example, when the operation corresponding to the user's intention is “Search for Park XXX in the vicinity.” and this operation is inexecutable because the space availability information of the outside-vehicle information indicates that the “Park XXX” is full, the output device 3 is controlled to output “Search for Park XXX in the vicinity.” as recommended operation.

After that, when the user selects this operation through the input device 5, the output device 3 is controlled to output a message “The Park XXX in the vicinity is full. A search for parking lots in the vicinity will be conducted.” or the like to output the message indicating that the operation above is inexecutable and also output the alternative operation. Thereafter, the determination part 21E instructs the operation execution device 4, automatically or upon the reception of the user's confirmation operation, to execute the alternative operation. This starts the search for parking lots in the vicinity.

If the alternative operation “Search for parking lots in the vicinity.” is suggested from the beginning, it may bring user's dissatisfaction that “the search does not extend to the brand of the parking lot”.

By determining the output mode of the operation as above, it is possible to indicate that the brand of the parking lot is also the search target, thereby reducing the user's dissatisfaction with the operation support device 2E in terms of convenience.

The description has been given of the case where the alternative operation is obtained by changing the abstraction level of the operation content. However, when the determination part 21E determines that the operation corresponding to the intention of the user is inexecutable, the determination part 21E may identify, as alternative operation, another operation that corresponds to this intention and that is executable.

For example, it is assumed that the operation “Search for convenience stores in the vicinity.” is identified as the operation corresponding to the user's intention “I want to go to the restroom.”, but there is no convenience store in the vicinity of the vehicle based on the facility information of the outside-vehicle information, and this operation is determined as being inexecutable.

In this case, the determination part 21E does not change the abstraction level, but identifies, as alternative operation, the operation with the search targets set as facilities having the restroom and belonging to another category set in the category item.

Note that, as for objects that can be of the intention contents of the user such as restrooms and automatic teller machines (ATMs), the presence or absence of such objects is set as attribute information of facilities and the like in the map information. Hence, the attribute information above is set to the operation content in the above-described reference data. This allows the determination part 21E to identify the facilities having the restroom and belonging to another category with reference to the reference data. Note that supermarkets and the like are conceivable as the facilities having the restroom and belonging to another category.

Even in this manner, the alternative operation for the operation corresponding to the intention of the user can be recommended, and the intention of the user is smoothly accomplished.

As described above, in the operation support device 2E according to the Embodiment 6, when the determination part 21E determines that the operation is inexecutable, the determination part 21E changes the abstraction level of the contents of the operation until the operation becomes executable. The recommendation-mode determination part 22 controls the output device 3 to output, as alternative operation, the operation whose abstraction level of the contents has been changed until the operation becomes executable. In this manner, the alternative operation for the operation corresponding to the intention of the user can be recommended, and thus the intention of the user is accomplished more smoothly.

Furthermore, in the operation support device 2E according to the Embodiment 6, when the determination part 21E determines that the operation corresponding to the intention of the user is inexecutable, the determination part 21E identifies another operation that corresponds to this intention and that is executable. The recommendation-mode determination part 22 controls the output device 3 to output the operation identified by the determination part 21E as the alternative operation. Even in this manner, the alternative operation for the operation corresponding to the intention of the user can also be recommended, and thus the intention of the user is accomplished more smoothly.

In the operation support device 2E according to the Embodiment 6, furthermore, the recommendation-mode determination part 22 controls the output device 3 to output, as recommended operation, content of the operation determined by the determination part 21E to be inexecutable, and, after that, controls the output device 3 to output a message indicating that the recommended operation is inexecutable and also output content of the operation identified by the determination part 21E as alternative operation. Even in this manner, it is possible to reduce the likelihood of the user feeling dissatisfied with the operation support device 2E in terms of convenience.

### Embodiment 7

Each of the Embodiments 1 to 6 presents the case where determination is made on whether the operation corresponding to the intention of the user is executable or not. In Embodiment 7, the operation determined by a determination part to be executable is classified depending on the degree of execution availability.

Note that an operation support device according to the Embodiment 7 differs from that in the Embodiment 1 in that the operation is classified depending on the degree of execution availability as described above, but the basic structure is the same as the structure described with reference to FIG. 1. Thus, hereinafter, description of the structure of the operation support device according to the Embodiment 7 will be made with reference to FIG. 1.

In the Embodiment 7, the determination part 21 classifies, depending on the degree of execution availability, the operation determined as being executable, which has been obtained by the determination on whether the operation corresponding to the intention of the user is executable or not.

For example, when execution availability is determined on the basis of the operation completion time presented in the Embodiment 2, the operation completion time is compared with a plurality of threshold values to determine the degree of the execution availability.

As the plurality of threshold values, an upper threshold value, an intermediate threshold value, and a lower threshold value may be used. When the operation completion time of the operation corresponding to the intention of the user is less than the upper threshold value and equal to or more than the intermediate threshold value, the degree of execution availability is determined as being “small”. When the operation completion time is less than the intermediate threshold value and is equal to or more than the lower threshold value, the degree of execution availability is determined as being “medium”. When the operation completion time is less than the lower threshold value, the degree of execution availability is determined as being “large”.

The recommendation-mode determination part 22 controls the output device 3 to output content of the operation corresponding to the user's intention in the mode corresponding to such degree of execution availability.

For example, it is assumed that condition where the degree of execution availability is “medium” is identified as a normal mode.

In this assumption, when the degree of execution availability is “large”, the volume of the voice guidance prompting selection of this operation is increased compared to the normal mode. At that time, the contents of the voice guidance may include a message indicating that the degree of execution availability is high. When displaying the recommended operation, a shortcut button and a text that prompt selection of this operation may be highlighted. Examples of the highlighting include a mode of changing to an attention-attracting color such as yellow, a mode of increasing the display size compared to the normal mode, and a mode of increasing the luminance compared to the normal mode.

On the other hand, when the degree of execution availability is “small”, the volume of the voice guidance prompting selection of this operation is lowered compared to the normal mode. At that time, the contents of the voice guidance may include a message indicating that the degree of execution availability is low. When the recommended operation is displayed, a shortcut button and a text that prompt selection of this operation may be displayed in a passive manner. Examples of the passive display include a mode of changing to a non-attention-attracting color such as blue, a mode of decreasing the display size compared to the normal mode, and a mode of decreasing the luminance compared to the normal mode. In this manner, the user can select the recommended operation depending on the degree of execution availability, and thus the intention of the user is accomplished more smoothly.

The determination part 21 may control the operation execution device 4 to execute, automatically or in the background, the operation whose degree of execution availability is higher than a threshold value.

For example, in order to promptly execute corresponding to the user's intention, when the degree of execution availability is higher than “medium”, that is, “large”, the determination part 21 instructs the operation execution device 4 to automatically execute this operation without recommending to the user.

Alternatively, when the operation is recommended to the user and selected as the operation to be executed, the determination part 21 may also instruct the operation execution device 4 to execute this operation automatically.

Even when another in-vehicle equipment is executing processing at that time, the operation execution device 4 is controlled to execute the above-mentioned operation in the background of the executed processing. Such a structure can promptly accomplish the intention of the user without delay due to the user operation in achieving the intention of the user.

The recommendation-mode determination part 22 may control the output device 3 to output content of the operation whose degree of execution availability is equal to or less than the threshold value in a mode that does not recommend the operation.

Until here, the operation content are suggested to the user in the mode of recommending the operation content by providing the voice guidance that prompts selection of the operation or displaying the shortcut button and text that prompt selection of this operation. On the contrary, the operation with the low degree of execution availability is suggested to the user in the mode that does not recommend the operation. For example, when the operation corresponding to the intention of the user is “search for supermarkets in the vicinity” and the degree of execution availability of this operation is “small”, the icons for the supermarkets may be simply displayed on the map.

In this manner, the operation with the low degree of execution availability is less likely to be selected and it is possible to reduce the situations where the intention of the user is not accomplished.

In addition, the recommendation-mode determination part 22 may control the output device 3 to output content of the operation whose degree of execution availability is equal to or less than the threshold value in a mode of indicating difficulty in executing this operation.

For example, while the shortcut button and the text prompting selection of this operation are selectable, they are displayed indistinctly as if to be grayed out. Even in this manner, the operation with the low degree of execution availability is less likely to be selected and it is possible to reduce the situations where the intention of the user is not accomplished.

Furthermore, the recommendation-mode determination part 22 may control the output device 3 not to output content the operation whose degree of execution availability is equal to or less than the threshold value. When the operation is possibly executable but the degree of execution availability thereof is low, it is conceivable that the operation turns to be inexecutable when the user selects the operation. In this case, the selection operation is wasted. Therefore, by not presenting, to the user, the operation whose degree of execution availability is equal to or less than the threshold value, such a wasteful operation can be prevented.

Furthermore, even for the operation whose degree of execution availability is equal to or less than the threshold value, the recommendation-mode determination part 22 may control the output device 3 to output this operation as recommended operation. In this case, when the recommended operation is designated as operation to be executed, the determination part 21 may control the operation execution device 4 to execute another operation whose degree of execution availability is higher than this operation and which relates to this operation.

For example, even when the operation corresponding to the user's intention is “Search for the coming service area.” and the degree of execution availability is “small”, the recommendation-mode determination part 22 controls the output device 3 to output this operation as recommended operation. When this operation is selected by the user, the determination part 21 identifies the operation “Search for the service area after next.”, which relates to the above-mentioned operation with a higher degree of execution availability, as alternative operation in a manner similar to the Embodiment 6, and controls the operation execution device 4 to execute this alternative operation. In this manner, the intention of the user can be accomplished smoothly.

As described above, in the operation support device 2 according to the Embodiment 7, the determination part 21 classifies the operation determined as being executable, depending on the degree of execution availability. The recommendation-mode determination part 22 controls the output device 3 to output content of the operation in the mode corresponding to the degree of execution availability. With such a structure, the user can select the recommended operation depending on the degree of execution availability, and thus the intention of the user is accomplished more smoothly.

Furthermore, in the operation support device 2 according to the Embodiment 7, the determination part 21 controls the operation execution device 4 to execute, automatically or in the background, the operation whose degree of execution availability is higher than the threshold value. With such a structure, the intention of the user can be accomplished promptly.

Furthermore, in the operation support device 2 according to the Embodiment 7, the recommendation-mode determination part 22 controls the output device 3 to output content of the operation whose degree of execution availability is equal to or less than the threshold value in the mode which does not recommend the operation.

With such a structure, the operation with the low degree of execution availability is less likely to be selected and it is possible to reduce the situations where the intention of the user is not accomplished.

Furthermore, in the operation support device 2 according to the Embodiment 7, the recommendation-mode determination part 22 controls the output device 3 to output the operation whose degree of execution availability is equal to or less than the threshold value in the mode of indicating difficulty in executing the operation. Even in this manner, the operation with the low degree of execution availability is less likely to be selected and it is possible to reduce the situations where the intention of the user is not accomplished.

Furthermore, in the operation support device 2 according to the Embodiment 7, the recommendation-mode determination part 22 controls the output device 3 not to output the operation whose degree of execution availability is equal to or less than the threshold value. Even in this manner, the operation with the low degree of execution availability is less likely to be selected and it is possible to reduce the situations where the intention of the user is not accomplished.

Furthermore, in the operation support device 2 according to the Embodiment 7, the recommendation-mode determination part 22 controls the output device 3 to output, as recommended operation, the operation whose degree of execution availability is equal to or less than the threshold value. When the recommended operation is designated as the operation to be executed, the determination part 21 controls the operation execution device 4 to execute another operation whose degree of execution availability is higher than this recommended operation and which relates to this recommended operation.

With such a structure, the intention of the user can be accomplished smoothly.

### Embodiment 8

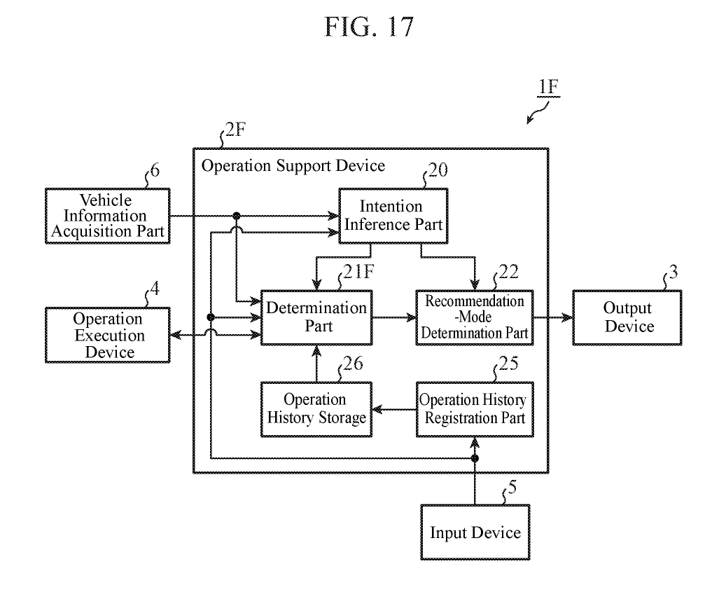

FIG. 17 is a block diagram illustrating a structure of an operation support system 1F according to Embodiment 8 of the present invention. The operation support system 1F is configured to recommend, from among the operations of equipment mounted in the vehicle, the operation corresponding to the intention of the user being an occupant to lead to the execution of the operation. As illustrated in FIG. 17, the operation support system 1F includes an operation support device 2F, an output device 3, an operation execution device 4, an input device 5, and a vehicle information acquisition part 6. The operation support device 2F is configured to infer the future intention of the user and control the output device 3 to output the operation corresponding to the inferred intention. The operation support device 2F includes an intention inference part 20, a determination part 21F, a recommendation-mode determination part 22, an operation history registration part 25, and an operation history storage 26.

Note that the same components as those in FIG. 1 are denoted by the same signs in FIG. 17, and the description thereof is omitted.

The operation history registration part 25 is configured to monitor the operation information about the user who uses the input device 5, and store the information as an operation history into the operation history storage 26 each time when the recommended operation is selected.

The operation history storage 26 is a component embodying a storage according to the present invention and configured to store the operation history of the execution of the recommended operation.

On the basis of the operation history read from the operation history storage 26, the determination part 21F determines whether the operation corresponding to the intention of the user is executable or not. For example, contents indicating whether the operation corresponding to the user's intention is the recommended one in the past, what the degree of execution availability at the time of the recommendation is, and its execution result are identified from the operation history information, and whether the operation is executable this time is determined accordingly. In this manner, it is possible to reduce the load of calculation for determining whether the operation corresponding to the intention of the user is executable and also accurately determine whether the operation is executable or not.

Note that the respective functions of the intention inference part 20, the determination part 21F, the recommendation-mode determination part 22, the operation history registration part 25, and the operation history storage 26 may be, as with the Embodiment 1, implemented by dedicated hardware, or implemented by software or firmware. In addition, some of these functions may be implemented by dedicated hardware, whereas the remainder may be implemented by software or firmware.

As described above, the operation support device 2F according to the Embodiment 8 includes the operation history storage 26 to store the operation history of the execution of the recommended operation and the operation history registration part 25 to register the operation history in the operation history storage 26. On the basis of the operation history read from the operation history storage 26, the determination part 21F determines whether the operation corresponding to the intention of the user is executable or not. With such a structure, it is possible to reduce the load of calculation for determining whether the operation corresponding to the intention of the user is executable or not, and also possible to accurately determine whether the operation is executable or not.

### Embodiment 9

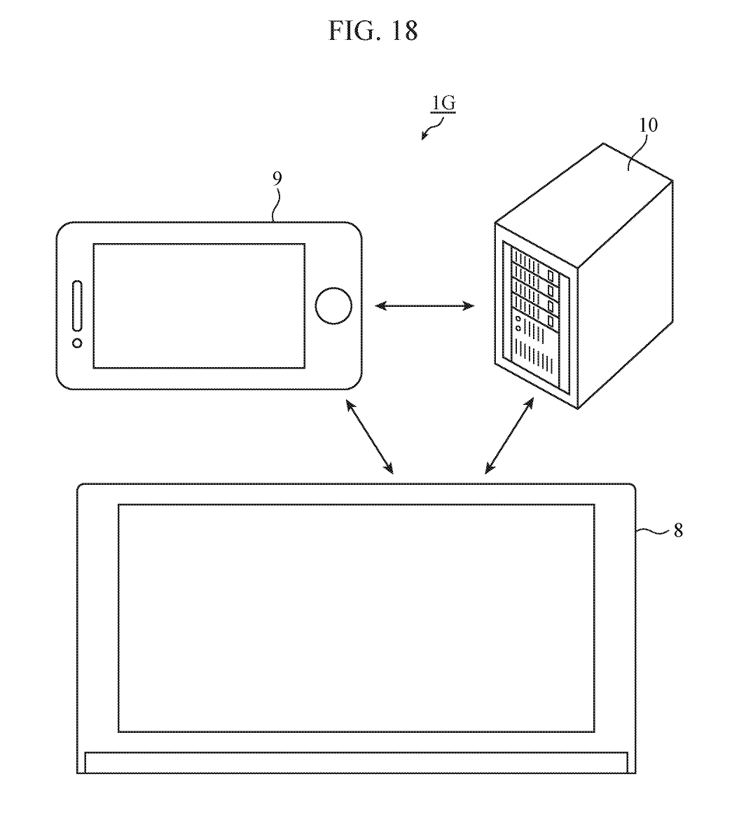

FIG. 18 is a block diagram illustrating a structure of an operation support system 1G according to the Embodiment 9 of the present invention. In the operation support system 1G illustrated in FIG. 18, in-vehicle equipment 8 provides operation support in cooperation with a mobile terminal 9 or a server 10.

First, a description will be given of the case where the in-vehicle equipment 8 functions as an operation support device in cooperation with the server 10.

The in-vehicle equipment 8 communicates with the server 10 directly or via the mobile terminal 9. In addition to a communication module that performs such communication, the server 10 includes the intention inference part 20, the determination part 21, and the recommendation-mode determination part 22 described in the Embodiment 1.

In other words, each function of the operation support device 2 is executed by the server 10, and the output contents acquired in this way are transmitted to the in-vehicle equipment 8 by the server 10.

The in-vehicle equipment 8 controls the output device 3 to output information indicating recommended operation received from the server 10.

When the recommended operation is selected using the input device 5, the in-vehicle equipment 8 controls the operation execution device 4 to execute this operation.

Next, a description will be given of the case where the in-vehicle equipment 8 functions as an operation support device in cooperation with the mobile terminal 9.

In addition to a communication module that communicates with the in-vehicle equipment 8, the mobile terminal 9 includes the intention inference part 20, the determination part 21, and the recommendation-mode determination part 22 described in the Embodiment 1.

In other words, each function of the operation support device 2 is executed by the mobile terminal 9, and the output contents acquired in this way are transmitted to the in-vehicle equipment 8 by the mobile terminal 9.

The in-vehicle equipment 8 controls the output device 3 to output information indicating recommended operation received from the mobile terminal 9.

When the recommended operation is selected using the input device 5, the in-vehicle equipment 8 controls the operation execution device 4 to execute this operation.

Next, a description will be given of the case where the in-vehicle equipment 8 functions as an operation support device in cooperation with the mobile terminal 9 and the server 10.

The in-vehicle equipment 8 includes a communication module that communicates between the in-vehicle equipment 8 and both the mobile terminal 9 and the server 10. In addition to a communication module that communicates with the in-vehicle equipment 8, the mobile terminal 9 and the server 10 each include any of the intention inference part 20, the determination part 21, and the recommendation-mode determination part 22.

In other words, the functions of the operation support device 2 are each executed by either the mobile terminal 9 or the server 10 and the output contents acquired in this way are transmitted to the in-vehicle equipment 8 by the mobile terminal 9 or the server 10.

The in-vehicle equipment 8 controls the output device 3 to output information indicating recommended operation received from the mobile terminal 9 or the server 10.

When the recommended operation is selected using the input device 5, the in-vehicle equipment 8 controls the operation execution device 4 to execute this operation.

As described above, in the operation support system 1G according to the Embodiment 9, the mobile terminal 9 or the server 10 includes the intention inference part 20, the determination part 21, and the recommendation-mode determination part 22.

Even in this manner, the operation corresponding to the intention of the user that is inferred is recommended in different modes depending on whether the operation is executable or not. This allows the user to select the executable operation easily, whereby the intention of the user is accomplished smoothly. Furthermore, since the user's processing of selecting an inexecutable operation is reduced, it is possible to reduce the likelihood of the user feeling dissatisfied with the operation support device 2 in terms of convenience.

Note that arbitrary combinations of the embodiments, modifications on arbitrary components in the embodiments, or omission of arbitrary components in the embodiments can be made in the present invention within the scope of the invention.

An operation support device according to the present invention is capable of accomplishing intention of the user smoothly through the recommended operation and reducing dissatisfaction of the user with the device in terms of convenience. Therefore, the operation support device according to the present invention is suitable for, for example, an operation support device serving as in-vehicle equipment.

### REFERENCE SIGNS LIST

1 and 1A to 1G: operation support system, 2 and 2A to 2F: operation support device, 3: output device, 4: operation execution device, 5: input device, 6: vehicle information acquisition part, 7: outside-vehicle information acquisition part, 8: in-vehicle equipment, 9: mobile terminal, 10: server, 20: intention inference part, 21 and 21A to 21F: determination part, 22: recommendation-mode determination part, 23: operation completion time calculator, 24: available time calculator, 25: operation history registration part, 26: operation history storage, 100: processing circuitry, 101: CPU, 102: memory.

1-17. (canceled)

18. An operation support device comprising:
an intention inference part to infer a future intention of a user;
a time calculator to calculate an available time during which operation is properly executable, the operation corresponding to the feature intention of the user inferred by the intention inference part;
a determination part to determine, on a basis of the available time, whether the operation is executable or not; and
a recommendation-mode determination part to control an output device to output content of the operation in different modes depending on a determination of the determination part regarding whether the operation is executable or not.

19. The operation support device according to claim 18, further comprising:
another time calculator to calculate intention accomplishment time information about a required time from when the operation is selected until execution of the selected operation is completed
wherein the determination part is configured to perform the determination of whether the operation is executable or not on a basis of the intention accomplishment time information and the available time.

20. The operation support device according to claim 18, wherein,
when the operation is determined as being inexecutable, the determination part is configured to change an abstraction level of content of the operation until the operation becomes executable, and
the recommendation-mode determination part is configured to control the output device to output content of the operation, whose abstraction level has been changed to become executable, as alternative operation.

21. The operation support device according to claim 18, wherein,
when the operation is determined as being inexecutable, the determination part is configured to identify another operation that corresponds to the intention of the user and that is executable, and
the recommendation-mode determination part is configured to control the output device to output content of said another operation identified by the determination part as alternative operation.

22. The operation support device according to claim 18, wherein,
when the operation is determined as being inexecutable, the determination part is configured to change an abstraction level of content of the operation until the operation becomes executable or identify another operation that corresponds to the intention of the user and that is executable, and
the recommendation-mode determination is configured to control the output device to output, as recommended operation, content of the operation determined as being inexecutable by the determination part, and, after that, control the output device to output a message indicating that the recommended operation is inexecutable and also output content of the operation identified by the determination part as alternative operation.

23. The operation support device according to claim 18, wherein
the determination part is configured to classify, depending on a degree of execution availability, the operation determined as being executable, and
the recommendation-mode determination part is configured to control the output device to output content of the operation in a mode corresponding to the degree of execution availability.

24. The operation support device according to claim 23, wherein the determination part is configured to control an operation execution device to execute, automatically or in a background, operation whose degree of execution availability is higher than a threshold value.

25. The operation support device according to claim 23, wherein the recommendation-mode determination part is configured to control the output device to output content of operation whose degree of execution availability is equal to or less than a threshold value in a mode that does not recommend the operation.

26. The operation support device according to claim 23, wherein the recommendation-mode determination part is configured to control the output device to output content of operation whose degree of execution availability is equal to or less than a threshold value in a mode of indicating difficulty in executing the operation.

27. The operation support device according to claim 23, wherein the recommendation-mode determination part is configured to control the output device not to output content of operation whose degree of execution availability is equal to or less than a threshold value.

28. The operation support device according to claim 23, wherein
the recommendation-mode determination part is configured to control the output device to output, as recommended operation, content of operation whose degree of execution availability is equal to or less than a threshold value, and
when the recommended operation is designated as operation to be executed, the determination part is configured to control an operation execution device to execute another operation whose degree of execution availability is higher than that of the recommended operation, said another operation being related to the recommended operation.

29. An operation support system comprising:
an output device to output information;
an intention inference part to infer a future intention of a user;
a time calculator to calculate an available time during which operation is properly executable, the operation corresponding to the feature intention of the user inferred by the intention inference part;
a determination part to determine, on a basis of the available time, whether the operation is executable or not; and
a recommendation-mode determination part to control the output device to output content of the operation in different modes depending on a determination of the determination part regarding whether the operation is executable or not.
